(19) United States
(12) Patent Application Publication
(10) Pub. No.: US 2025/0105599 A1
(43) Pub. Date: Mar. 27, 2025

(54) BUS BAR

(71) Applicants: YAZAKI CORPORATION, Tokyo (JP); TOYOTA JIDOSHA KABUSHIKI KAISHA, Aichi-ken (JP)

(72) Inventors: Yoshitake Mitsuhashi, Kakegawa-shi (JP); Jo Naito, Kakegawa-shi (JP); Nobuyuki Oka, Kakegawa-shi (JP); Kozue Yorifuji, Fuji-shi (JP); Akinori Goto, Sunto-gun (JP); Satoru Ishikawa, Sunto-gun (JP)

(21) Appl. No.: 18/889,289

(22) Filed: Sep. 18, 2024

(30) Foreign Application Priority Data
Sep. 21, 2023 (JP) 2023-154106

(51) Int. Cl. H02B 1/54; H02B 1/20; H02G 3/08; H02G 5/08

(52) U.S. Cl. CPC H02B 1/54; H02B 1/20; H02G 3/081; H02G 5/08

(57) ABSTRACT

A bus bar includes: a bus bar base portion having a flat plate shape; and a bus bar terminal connection portion having a male tab shape erected from the bus bar base portion, in which the bus bar terminal connection portion is electrically connected to a relay terminal connection portion of a relay component via a relay terminal fitting, and a reinforcing rib is provided on the bus bar base portion, the reinforcing rib protruding from a flat surface of the bus bar base portion at least at one position on the flat surface and suppressing deformation caused by vibration accompanying driving of the relay component transmitted to the bus bar terminal connection portion.

### CROSS-REFERENCE TO RELATED APPLICATION(S)

The present application claims priority to and incorporates by reference the entire contents of Japanese Patent Application No. 2023-154106 filed in Japan on Sep. 21, 2023.

### BACKGROUND OF THE INVENTION

### 1. Field of the Invention

The present invention relates to a bus bar.

### 2. Description of the Related Art

A bus bar is housed in a housing of an electrical connection box such as a junction box, and electrically connects at least two electrical connection target components. The bus bar is, for example, a plate-like conductive member press-molded using a metal plate as a base material, and includes a terminal connection portion formed in a male tab shape to which the electrical connection target component is directly or indirectly connected. This type of bus bar is disclosed in Japanese Patent Application Laid-open No. 2010-259228 below.

Meanwhile, in a case where the electrical connection target component is a relay component that can be an excitation source, vibration accompanying driving of the relay component is transmitted to the terminal connection portion of the bus bar, and the vibration is propagated from the terminal connection portion as a starting point. The bus bar is housed in the housing of the electrical connection box with a certain degree of play (slack), which may lead to abnormal noise caused by vibration of the bus bar. The bus bar may be electrically connected to the relay component via a relay terminal fitting. In this case, the relay terminal fitting indirectly connects the male tab-shaped terminal connection portion of the bus bar to a male tab-shaped terminal connection portion of the relay component. Here, when the relay terminal fitting physically and electrically connects the terminal connection portions by using a spring force, it is desirable that the relay terminal fitting absorbs and damps the vibration accompanying the driving of the relay component. However, the vibration may be amplified by the relay terminal fitting and transmitted to the terminal connection portion of the bus bar.

### SUMMARY OF THE INVENTION

Therefore, an object of the present invention is to provide a bus bar capable of suppressing propagation of vibration.

In order to achieve the above mentioned object, a bus bar according to one aspect of the present invention includes a bus bar base portion having a flat plate shape; and a bus bar terminal connection portion having a male tab shape erected from the bus bar base portion, wherein the bus bar terminal connection portion is electrically connected to a relay terminal connection portion of a relay component via a relay terminal fitting, and a reinforcing rib is provided on the bus bar base portion, the reinforcing rib protruding from a flat surface of the bus bar base portion at least at one position on the flat surface and suppressing deformation caused by vibration accompanying driving of the relay component transmitted to the bus bar terminal connection portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view for describing an electrical connection box in which a bus bar of an embodiment is provided;

FIG. 2 is a perspective view for describing the electrical connection box in which the bus bar of the embodiment is provided;

FIG. 3 is a plan view illustrating the bus bar and a relay terminal fitting of the embodiment housed in a bus bar housing chamber;

FIG. 4 is a cross-sectional view of the periphery of the relay terminal fitting in a cross section taken along line X-X of FIG. 2;

FIG. 5 is a diagram illustrating an example of a simulation analysis result of an equivalent radiation power level related to the bus bar of the embodiment;

FIG. 6 is a diagram illustrating another example of the simulation analysis result of the equivalent radiation power level related to the bus bar of the embodiment;

FIG. 7 is a plan view illustrating an example of the bus bar according to the embodiment;

FIG. 8 is a plan view illustrating another example of the bus bar according to the embodiment; and

FIG. 9 is a plan view illustrating another example of the bus bar according to the embodiment.

### DETAILED DESCRIPTION OF THE PREFERRED EMBODIMENTS

Hereinafter, an embodiment of a bus bar according to the present invention will be described in detail with reference to the drawings. Note that the present invention is not limited by the embodiment.

### Embodiment

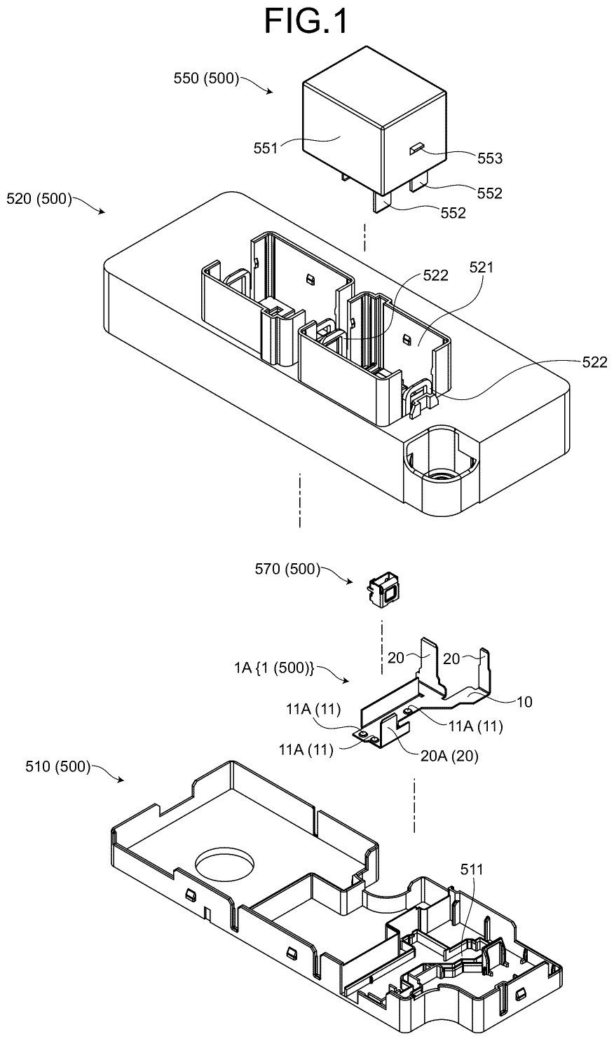

One embodiment of the bus bar according to the present invention will be described with reference to FIGS. 1 to 9.

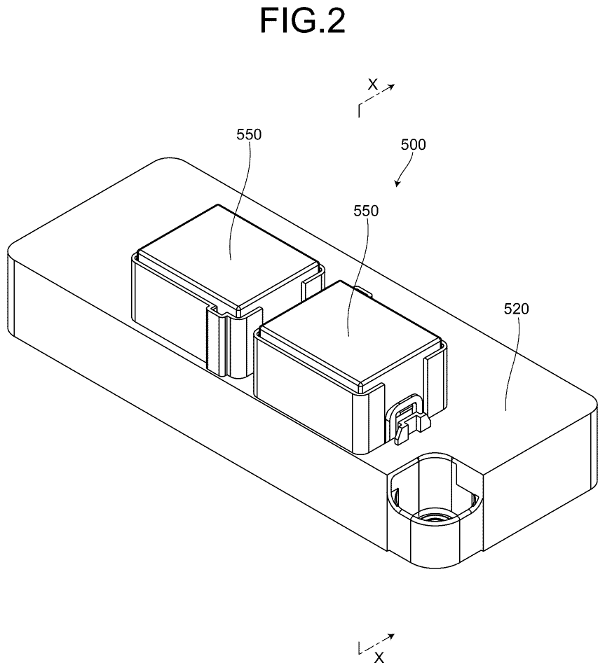

Reference Numeral 1 illustrated in FIG. 1 indicates the bus bar of the present embodiment. The bus bar 1 is housed in a housing of an electrical connection box 500 such as a junction box, and electrically connects at least two electrical connection target components (FIGS. 1 to 3). The bus bar 1 illustrated here electrically connects a relay component 550 as an electrical connection target component to another electrical connection target component (FIGS. 1 and 2).

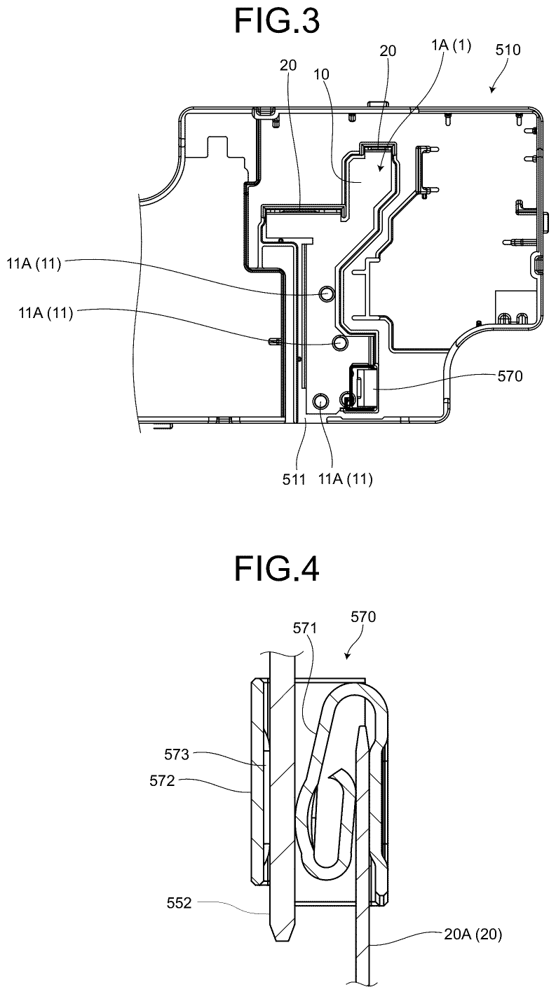

The bus bar 1 is a conductive member formed in a plate shape and formed of a conductive material such as a metal material. For example, the bus bar 1 is press-molded using a metal plate as a base material. The bus bar 1 includes a flat plate-shaped base portion (hereinafter, referred to as a “bus bar base portion”) 10 and a male tab-shaped terminal connection portion (hereinafter, referred to as a “bus bar terminal connection portion”) 20 erected from the bus bar base portion 10 (FIGS. 1 and 3). The bus bar 1 illustrated here includes a plurality of bus bar terminal connection portions 20, and the relay component 550 is electrically connected to one (hereinafter, referred to as a “bus bar terminal connection portion 20A”) of the plurality of bus bar terminal connection portions 20 via a relay terminal fitting 570 (FIGS. 1, 3, and 4).

Here, the relay component 550 includes a relay body 551 and a terminal connection portion (hereinafter, referred to as a “relay terminal connection portion”) 552 protruding from the relay body 551 (FIG. 1). The relay terminal connection portion 552 formed in a male tab shape is provided in the relay component 550 illustrated here.

In addition, the relay terminal fitting 570 includes an electrical connection portion 571 that physically and electrically connects the bus bar terminal connection portion 20A and physically and electrically connects the relay terminal connection portion 552, the electrical connection portion 571 being provided in a cylinder of a cylindrical terminal body 572 (FIG. 4). Therefore, the bus bar terminal connection portion 20A is electrically connected to the relay terminal connection portion 552 via the relay terminal fitting 570. The relay terminal fitting 570 illustrated here is press-molded using a metal plate as a base material.

The electrical connection portion 571 is bent and deformed as the bus bar terminal connection portion 20A is inserted, and a reaction force (spring force) thereof is applied to a flat surface of the bus bar terminal connection portion 20A to clamp the bus bar terminal connection portion 20A between the electrical connection portion 571 and an inner wall surface of the terminal body 572 (FIG. 4). Therefore, the bus bar terminal connection portion 20A is physically and electrically connected to the relay terminal fitting 570 by the spring force of the relay terminal fitting 570 applied to the flat surface. In addition, the electrical connection portion 571 is bent and deformed as the relay terminal connection portion 552 is inserted, and a reaction force (spring force) thereof is applied to a flat surface of the relay terminal connection portion 552 to clamp the relay terminal connection portion 552 between the electrical connection portion 571 and the inner wall surface of the terminal body 572 (FIG. 4). Therefore, the relay terminal connection portion 552 is physically and electrically connected to the relay terminal fitting 570 by the spring force of the relay terminal fitting 570 applied to the flat surface. Here, the relay terminal connection portion 552 is clamped between a bulging portion 573 bulging from the inner wall surface of the terminal body 572 and the electrical connection portion 571. The electrical connection portion 571 illustrated here is formed in a U shape sandwiched between the bus bar terminal connection portion 20A and the relay terminal connection portion 552 in the cylinder of the terminal body 572, and applies the reaction forces (spring forces) in opposite directions to the bus bar terminal connection portion 20A and the relay terminal connection portion 552.

The electrical connection box 500 includes the housing that houses the bus bar 1, the relay component 550, and the relay terminal fitting 570. The housing includes a case member 510 and a cover member 520 which are formed of an insulating material such as a synthetic resin and are assembled to each other (FIG. 1).

A housing chamber (hereinafter, referred to as a “bus bar housing chamber”) 511 that houses the bus bar 1 is formed in the case member 510 (FIGS. 1 and 3). The bus bar 1 is housed in the bus bar housing chamber 511 in a state in which the relay terminal fitting 570 is assembled to the bus bar terminal connection portion 20A. Therefore, the relay terminal fitting 570 is also housed in the bus bar housing chamber 511.

The cover member 520 covers the bus bar 1 and the case member 510 by being assembled to the case member 510. The cover member 520 illustrated here covers the bus bar 1 and the relay terminal fitting 570. Therefore, the cover member 520 has a through-hole for inserting the relay terminal connection portion 552 into the relay terminal fitting 570. In the cover member 520, a standing wall surrounding the through-hole is provided on an outer wall surface, and a space inside the standing wall is used as a housing chamber (hereinafter, referred to as a “relay housing chamber”) 521 for the relay component 550 (FIG. 1).

A part of the standing wall of the cover member 520 is cut out, and a holding portion (hereinafter, referred to as a “relay holding portion”) 522 that holds the relay component 550 in the relay housing chamber 521 is provided at the cut-out part (FIG. 1). The relay holding portion 522 forms a so-called locking mechanism that holds a claw portion 553 by being hooked on the claw portion 553 protruding from an outer wall surface of the relay body 551 (FIG. 1).

In the housing, the case member 510 does not include a holding mechanism that holds the bus bar 1 in the bus bar housing chamber 511 (for example, a mechanism in which a through-hole is provided in the bus bar 1, a claw portion to be inserted into the through-hole is provided on a standing wall of the bus bar housing chamber 511, and the claw portion is hooked on a peripheral edge of the through-hole to hold the bus bar 1 in the bus bar housing chamber 511). However, in the housing, the bus bar 1 is indirectly held with respect to the cover member 520 via the relay component 550 held by the cover member 520 and the relay terminal fitting 570 to which the relay terminal connection portion 552 of the relay component 550 is fitted and connected.

Meanwhile, in the relay component 550, vibration is caused by an on/off switching operation, and the vibration is transmitted to the relay terminal connection portion 552. The vibration accompanying the driving of the relay component 550 is transmitted from the relay terminal connection portion 552 to the bus bar terminal connection portion 20A via the relay terminal fitting 570, and is transmitted from the bus bar terminal connection portion 20A to the bus bar base portion 10. Since the bus bar 1 is not fixed to the case member 510, when the vibration of the relay component 550 is propagated to the bus bar base portion 10, there is a possibility that abnormal noise occurs due to the vibration of the bus bar base portion 10. In addition, even when the bus bar 1 in the bus bar housing chamber 511 is held by the case member 510 using the holding mechanism described above, the holding mechanism is provided with play (slack) between the claw portion and the through-hole, so that the bus bar 1 can be relatively moved with respect to the case member 510 in the bus bar housing chamber 511 by the degree of play. Therefore, even in a case where the bus bar 1 is held by the case member 510 using the holding mechanism, when the vibration of the relay component 550 is propagated to the bus bar base portion 10, the vibration of the bus bar base portion 10 may cause abnormal noise.

Therefore, in the present embodiment, by forming the bus bar 1 as described below, the occurrence of abnormal noise caused by vibration accompanying the driving of the relay component 550 is suppressed. In the bus bar 1 of the present embodiment, a reinforcing rib 11 is provided on the bus bar base portion 10 (FIG. 1) and suppresses deformation caused by the vibration accompanying the driving of the relay component 550 transmitted to the bus bar terminal connection portion 20A, so that the occurrence of abnormal noise caused by the vibration is suppressed. The reinforcing rib 11 protrudes from a flat surface of the bus bar base portion 10 at least at one position on the flat surface.

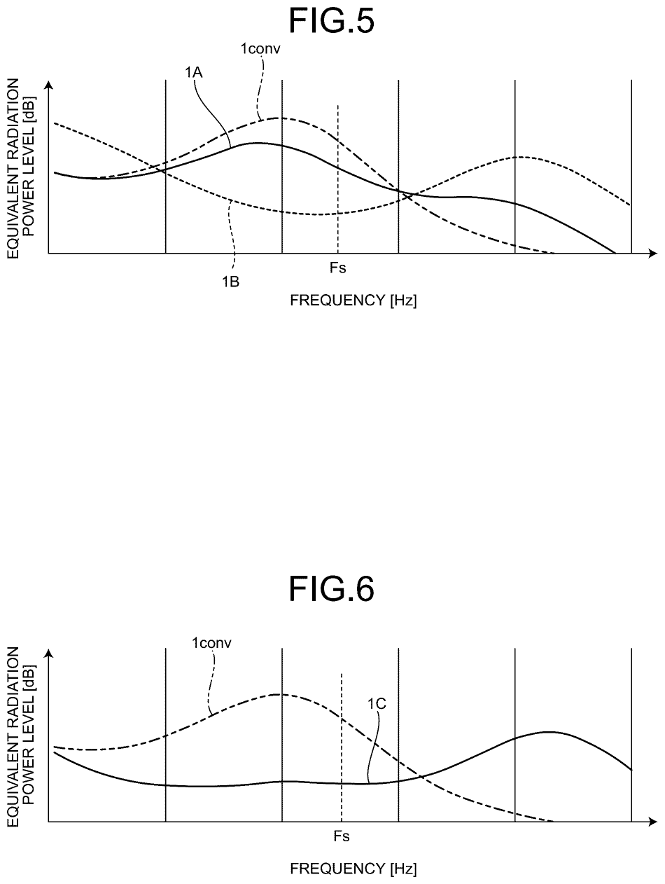

A position where the reinforcing rib 11 is disposed is determined as follows. Here, an equivalent radiation power level of a bus bar 1conv according to the related art is obtained by simulation analysis (a line with alternating long and two short dashes in FIGS. 5 and 6). In the bus bar 1conv according to the related art, the reinforcing rib 11 is not provided on the bus bar base portion 10, and the relay component 550 is assembled to the bus bar terminal connection portion 20A via the relay terminal fitting 570. As a result of the analysis, in the bus bar 1conv according to the related art, vibration occurs in the vicinity of the bus bar terminal connection portion 20A in the bus bar base portion 10 (that is, the vicinity of a vibration input portion of the relay component 550 in the bus bar base portion 10) and a portion having low rigidity in the entire bus bar base portion 10. Therefore, in the bus bar 1 of the present embodiment, the reinforcing rib 11 is provided in the vicinity of the bus bar terminal connection portion 20A in the bus bar base portion 10 (that is, the vicinity of the vibration input portion of the relay component 550 in the bus bar base portion 10) and the portion having low rigidity in the entire bus bar base portion 10. In this example, the reinforcing rib 11 is provided at a position and in a quantity where the equivalent radiation power level is lowered at a specific frequency (a frequency of the vibration accompanying the driving of the relay component 550) Fs.

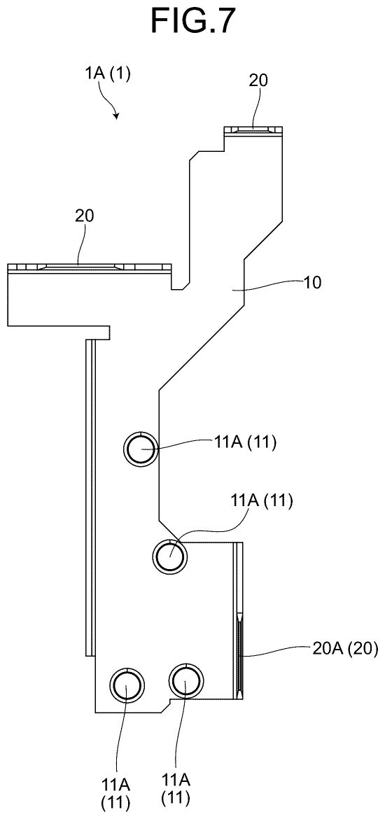

For example, FIG. 7 illustrates a bus bar 1A including reinforcing ribs 11A formed in a circular shape. In the bus bar 1A, the reinforcing ribs 11A are provided at four positions on a bus bar base portion 10, so that the rigidity is increased at each position where the reinforcing rib 11A is provided. A solid line in FIG. 5 indicates an equivalent radiation power level of the bus bar 1A. The equivalent radiation power level of the bus bar 1A at the specific frequency Fs can be lower than that of the bus bar 1conv according to the related art.

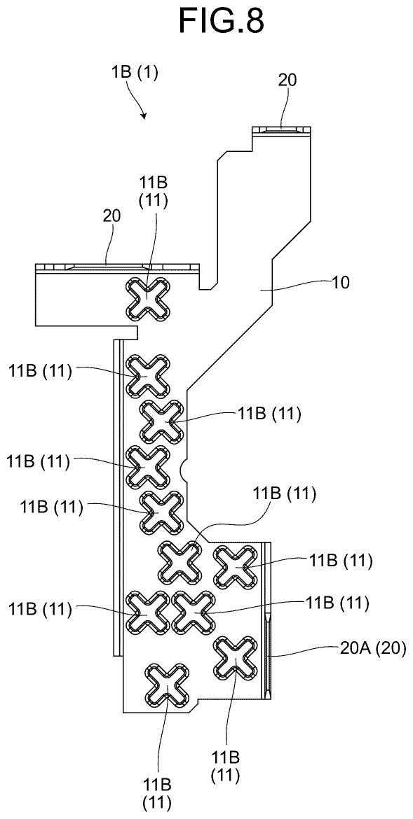

For example, FIG. 8 illustrates a bus bar 1B including reinforcing rib 11B formed in a cross shape such as a cruciform or a diagonal cross shape. In the bus bar 1B, the reinforcing ribs 11B are provided at 11 positions on a bus bar base portion 10, so that the rigidity is increased at each position where the reinforcing rib 11B is provided. A broken line in FIG. 5 indicates an equivalent radiation power level of the bus bar 1B. The equivalent radiation power level of the bus bar 1B at the specific frequency Fs can be lower than that of the bus bar 1conv according to the related art. Furthermore, the equivalent radiation power level of the bus bar 1B at the specific frequency Fs can be lower than that of the bus bar 1A in which the circular reinforcing rib 11A is provided.

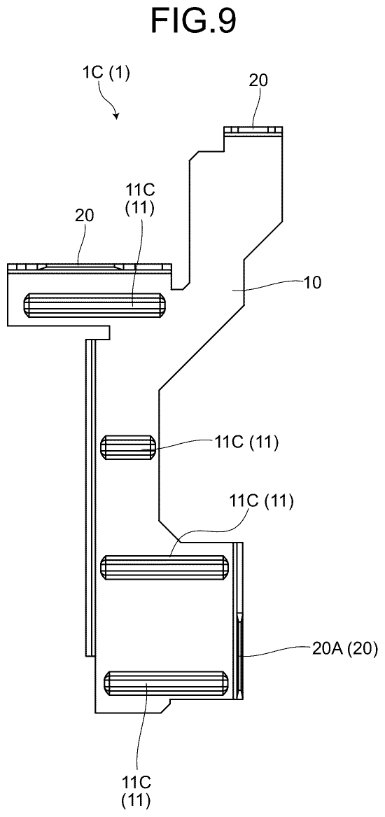

Further, the reinforcing rib 11 may be formed in a linear shape extending in the same direction as a plate thickness direction of the bus bar terminal connection portion 20A. FIG. 9 illustrates a bus bar 1C including linear reinforcing ribs 11C. In the bus bar 1C, the reinforcing ribs 11C are provided at four positions on a bus bar base portion 10, so that the rigidity is increased at each position where the reinforcing rib 11C is provided. In this example, the four reinforcing ribs 11C are arranged at substantially equal intervals. A solid line in FIG. 6 indicates an equivalent radiation power level of the bus bar 1C. The equivalent radiation power level of the bus bar 1C at the specific frequency Fs can be lower than that of the bus bar 1conv according to the related art.

As described above, the bus bar 1 (1A, 1B, and 1C) of the present embodiment can be increased in rigidity by the reinforcing ribs 11 (11A, 11B, and 11C) provided on the bus bar base portion 10, and propagation of vibration accompanying the driving of the relay component 550 to the bus bar base portion 10 can be suppressed. Therefore, the bus bar 1 (1A, 1B, and 1C) can suppress the occurrence of abnormal noise caused by the vibration thereof. Further, in the bus bar 1 (1A, 1B, and 1C), when the relay terminal fitting 570 absorbs and damps the vibration caused by the driving of the relay component 550, the propagation of the vibration to the bus bar base portion 10 can be further suppressed, so that the occurrence of abnormal noise caused by the vibration of the bus bar 1 can be further suppressed. On the other hand, in the bus bar 1 (1A, 1B, and 1C), the reinforcing rib 11 (11A, 11B, and 11C) is provided at an appropriate position, so that it is possible to suppress the occurrence of abnormal noise caused by the vibration thereof even when the relay terminal fitting 570 amplifies the vibration accompanying the driving of the relay component 550.

Furthermore, since the bus bar 1 (1A, 1B, and 1C) of the present embodiment can suppress the vibration, abrasion of a contact point between the bus bar terminal connection portion 20A and the relay terminal fitting 570 can also be suppressed.

The bus bar according to the present embodiment can be increased in rigidity by the reinforcing rib provided on the bus bar base portion, and propagation of vibration accompanying the driving of the relay component to the bus bar base portion can be suppressed. Therefore, the bus bar can suppress the occurrence of abnormal noise caused by the vibration thereof. Further, in the bus bar, when the relay terminal fitting absorbs and damps the vibration caused by the driving of the relay component, the propagation of the vibration to the bus bar base portion can be further suppressed, so that the occurrence of abnormal noise caused by the vibration of the bus bar can be further suppressed. On the other hand, in the bus bar, the reinforcing rib is provided at an appropriate position, so that it is possible to suppress the occurrence of abnormal noise caused by the vibration thereof even when the relay terminal fitting amplifies the vibration accompanying the driving of the relay component.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bus bar comprising:
a bus bar base portion having a flat plate shape; and
a bus bar terminal connection portion having a male tab shape erected from the bus bar base portion, wherein
the bus bar terminal connection portion is electrically connected to a relay terminal connection portion of a relay component via a relay terminal fitting, and
a reinforcing rib is provided on the bus bar base portion, the reinforcing rib protruding from a flat surface of the bus bar base portion at least at one position on the flat surface and suppressing deformation caused by vibration accompanying driving of the relay component transmitted to the bus bar terminal connection portion.

2. The bus bar according to claim 1, wherein
the reinforcing rib is formed in a circular shape or a cross shape.

3. The bus bar according to claim 1, wherein
the reinforcing rib is formed in a linear shape extending in the same direction as a plate thickness direction of the bus bar terminal connection portion.

4. The bus bar according to claim 1, wherein
the bus bar terminal connection portion is physically and electrically connected to the relay terminal fitting by a spring force of the relay terminal fitting applied to a flat surface of the bus bar terminal connection portion.

5. The bus bar according to claim 2, wherein
the bus bar terminal connection portion is physically and electrically connected to the relay terminal fitting by a spring force of the relay terminal fitting applied to a flat surface of the bus bar terminal connection portion.

6. The bus bar according to claim 3, wherein
the bus bar terminal connection portion is physically and electrically connected to the relay terminal fitting by a spring force of the relay terminal fitting applied to a flat surface of the bus bar terminal connection portion.
